(19) United States
(12) Patent Application Publication
(10) Pub. No.: US 2009/0102184 A1
(43) Pub. Date: Apr. 23, 2009

(54) PLUG CONNECTOR FOR PLASTIC PIPE CONDUITS

(76) Inventors: Martin Lechner, Lindlar (DE); Norbert Terlau, Kurten (DE)

Correspondence Address: Brinks Hofer Gilson & Lione/Ann Arbor, 524 South Main Street, Suite 200, Ann Arbor, MI, 48104, US

(21) Appl. No.: 12/297,758

(22) PCT Filed: Apr. 13, 2007
(86) PCT No.: PCT/EP2007/053623

§ 371 Date: Oct. 20, 2008

(30) Foreign Application Priority Data
Apr. 18, 2006 (DE) 20 2006 006 304.8

(51) Int. Cl. F16L 37/092

(52) U.S. Cl. 285/33

(57) ABSTRACT

A plug connector for inserting a tubular plug-in part in a fluid-tight manner, useful for plastic pipe conduits is provided, consisting of a housing part with a plug-in receptacle, a retaining element and a fluid seal arranged in the plug receptacle; the housing part having a two-piece base part consisting of a receiving part for the retaining element and a connection part for connection of the housing part, to e.g., a threaded bore.

### CROSS REFERENCE TO RELATED APPLICATIONS

This application claims priority to German patent application number DE 20 2006 006 304.8, filed Apr. 18, 2006, and PCT/EP2007/053623, filed Apr. 13, 2007.

### FIELD OF THE INVENTION

The present invention relates to a plug connector for plastic pipe conduits.

### BACKGROUND OF THE INVENTION

Examples of prior-art in connection with plug connectors include EP 0 753 698 B1, EP 0 733 844 B1 and DE 203 19 959 U1 (US 2007/0284875 A1) which describe various applications and designs of connection devices.

EP 0 733 844 B1 describes a connection device for the quick and releasable connection of at least one plastic pipe conduit, consisting of a housing part with at least one receiving opening for the insertion of pipe conduit and of a clamping ring which is arranged in the receiving opening and interacts with an inner cone of the housing part via an outer cone for locking the pipe conduit, the two-piece housing part consisting, for releasability of the pipe conduit, of a base part and an insert part which is connected releasably thereto and has the inner cone, and the insert part being connected to the base part via a snap-action positive-fit connection. Provision is made for the insert part to have an inner, peripheral sealing lip for sealing against the outer circumferential surface of the pipe conduit, the sealing lip extending obliquely inward, prior to insertion of the pipe conduit, in the insertion direction in such a way that it is widened somewhat resiliently by the inserted pipe conduit and then butts against the same in a sealing manner.

EP 0 753 698 B1 describes a plug-in connection for the connection of pressure medium pipes, consisting of a housing part with a socket having an opening on one side for insertion of a plug-in portion formed in particular by a pipe conduit end, wherein at least one retaining element and at least one sealing element which extends out from the retaining element in the direction away from the opening are arranged within the socket on the side facing the opening, and during the process of inserting the plug-in portion into the socket of the housing part first of all a retaining function is ensured and additionally in the further course of the insertion process a sealing of the plug-in portion relative to the housing part is ensured by way of the sealing element, the housing part having a leakage path in such a way that in an inserted position of the plug-in portion, in which the latter is locked by the retaining element but not yet sealed by way of the sealing element, a perceptible lack of sealing is ensured within defined limits. In this case, provision is made for a valve element to be associated with the leakage path in such a way that, in the inserted position of the plug-in portion in which the latter is not yet sealed by way of the sealing element, on the one hand the pressure medium can escape by way of the leakage path, but on the other hand penetration of particles of dirt and the like from the exterior into the interior of the housing is excluded.

DE 203 19 959 U1 (US 2007/0284875 A1) describes a plug connector for fluid conduits, consisting of a housing part with a plug receptacle for inserting a tubular plug-in part in a fluid-tight manner, a retaining element for locking the inserted plug-in part and a fluid seal for sealing it being arranged in the plug receptacle, and the two-piece housing part consisting of a base part and an insert part connected thereto via a snap-action positive-fit connection. In this case, provision is made for the two-piece base part in turn also to consist of a receiving part for the retaining element, the fluid seal and the insert part and also of a connection part for connection of the housing part to a fluid conduit.

At the same time, DE 203 19 959 U1 (US 2007/0284875 A1) also claims a plug connector for fluid conduits that can have the foregoing features, consisting of a housing part with a plug receptacle for inserting a tubular plug-in part in a fluid-tight manner, wherein, arranged within the plug receptacle, starting from a mouth-site dirt seal as seen in the insertion direction, there is firstly a retaining element for locking the inserted plug-in part and, adjoining this, a fluid seal, a leakage path being formed in such a way that, in a pre-locked position of the plug-in part, in which the latter is locked by the retaining element but not yet sealed by way of the fluid seal, a physically perceptible lack of sealing is ensured within defined limits. In this case, provision is made for the leakage path to be formed by depressions which are arranged on the outer circumference of the plug-in part and are arranged, in the pre-locked position, on the one hand in the region of the fluid seal and on the other hand in the region of the dirt seal. In one-part connection pieces of a similar type that are currently used (EP 0 753 698 B1, EP 0 733 844 B1), receiving parts having a retaining element and ring seal are conventionally inserted into a metal screw-in connection piece. The drawback of these plug-in connections is that the metal content is very large and therefore the costs for the material and machining are also accordingly high.

Two-part embodiments having a reduced metal content are therefore also used. In these two-part plug-in connections, preassembled plastic receiving parts having a retaining element and ring seal are conventionally fastened to screw-in parts, as may be inferred from DE 203 19 959 U1 (US 2007/0284875 A1). These known plug-in connections follow the basic principle of “retaining before sealing”. The drawback of these plug connectors is that apart from the main ring seal, which seals the pipe relative to the receiving part, a further ring seal has to seal the receiving part relative to the screw-in part. On the one hand, this causes high costs and, on the other hand, a point is formed at which a lack of sealing can occur.

### SUMMARY OF THE INVENTION

An object of the present invention is providing a multipart plug connector that has simplified sealing.

According to the invention, this is achieved in that the fluid seal for sealing the inserted tubular plug-in part is arranged radially between the connection part and the tubular plug-in part.

Provided herein is a plug connector for inserting a tubular plug-in part in a fluid tight manner, useful for plastic pipe conduits, consisting of a housing part comprising a plug receptacle for inserting the tubular plug-in part; a retaining element for locking the inserted plug-in part; and a fluid seal for sealing the locked plug-in part the fluid seal being located in the plug receptacle, the housing part having a two-piece base part consisting of a receiving part for the retaining element and a connection part for connecting the housing part to a threaded bore, wherein the fluid seal for sealing the inserted plug-in part is arranged radially between the connection part and the tubular plug-in part.

As a result of the fact that the fluid seal for sealing the inserted plug-in part is arranged between the connection part and the tubular plug-in part, it is advantageously achieved that apart from the main ring seal, which is formed by the fluid seal and seals the pipe relative to the receiving part, no further ring seal has to seal the receiving part relative to the screw-in part. Various technical embodiments, all of which have in common the fact that the fluid seal, especially a ring seal, on the pipe connection side is the sole interface to the pressurized space within the plug-in connection, are in this case possible for the plug connector according to the invention.

Further advantageous features of the invention are contained in the following description.

### BRIEF DESCRIPTION OF THE DRAWINGS

The drawings show exemplary embodiments of the present invention which are described below in greater detail. The drawings show:

FIG. 1 is a overall perspective view of a plug connector according to the invention;

FIG. 2 is a longitudinal section through the plug connector according to the invention illustrated in FIG. 1;

FIG. 3 is a further longitudinal section through the plug connector according to the invention illustrated in FIG. 1, taken along the line III-III in FIG. 2;

FIG. 4 is a longitudinal section through a component associated with the plug connector according to the invention;

FIG. 5 is a cross section through the component illustrated in FIG. 4, taken along the line V-V in FIG. 4;

FIG. 6 is a longitudinal section through a further component associated with the plug connector according to the invention;

FIG. 7 is a view of a longitudinal section of a further embodiment of a plug connector according to the invention;

FIG. 8 is a further longitudinal section through the plug connector according to the invention illustrated in FIG. 7, taken along the line VIII-VIII in FIG. 7;

FIG. 9 is a view similar to FIGS. 3 and 8 in a variant embodiment;

FIGS. 10 and 11 are longitudinal sections of two further embodiments of plug connectors according to the invention;

FIG. 12 is a cross section through a further embodiment of the invention;

FIG. 13 is an enlarged view of the detail denoted by B in FIG. 12;

FIG. 14 is the view of a further embodiment, cut in half, of the invention; and

FIG. 15 shows the connection part of the embodiment illustrated in FIG. 14.

### DETAILED DESCRIPTION OF THE INVENTION

In the various Figures, like parts are provided in all cases with the same reference numerals and will therefore generally each be described only once hereinafter.

Provided herein is a plug connector for inserting a tubular plug-in part in a fluid tight manner, useful for plastic pipe conduits, consisting of a housing part comprising a plug receptacle for inserting the tubular plug-in part; a retaining element for locking the inserted plug-in part; and a fluid seal for sealing the locked plug-in part, the fluid seal being located in the plug receptacle, the housing part having a two-piece base part consisting of a receiving part for the retaining element and a connection part for connecting the housing part to a threaded bore, wherein the fluid seal for sealing the inserted plug-in part is arranged radially between the connection part and the tubular plug-in part.

Further provided is the plug connector, wherein the housing part comprises a base part and an insert part connected thereto by a snap-action positive-fit connection.

Further provided is the plug connector, wherein the connection part is made of metal, and the receiving part is made of plastic.

Further provided is the plug connector, wherein the receiving part is screwed onto the connection part.

Further provided is the plug connector, wherein the receiving part is connected in a rotationally fixed manner to the connection part, the receiving part surrounding an outer contour of the connection part and being adapted to the shape thereof.

Further provided is the plug connector, wherein the outer contour of the connection part (14) is polygonal or knurled in its configuration or comprises two undersized key surfaces.

Further provided is the plug connector, having a circumference comprising one or more non-positive/positive-fit elements, impressed into an inner wall of the receiving part, and arranged on the circumference of the connection part to increase the strength of the connection between the connection part of the base part of the housing part and the receiving part.

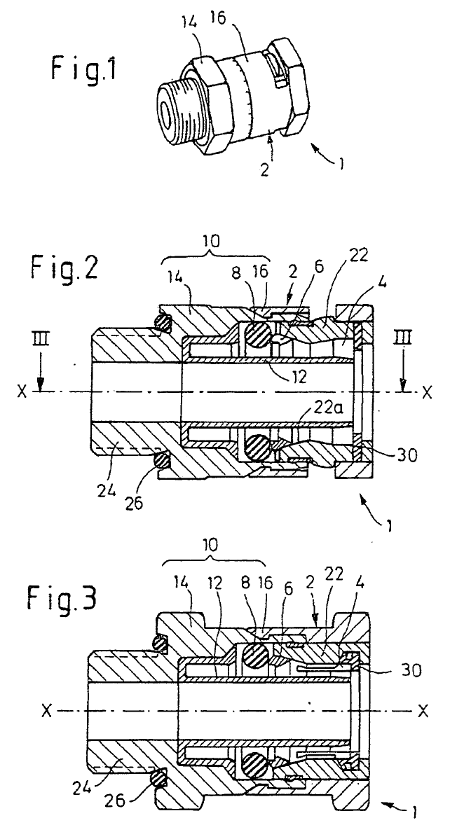

As may be seen in FIGS. 1 to 3, a plug connector 1 for plastic pipe conduits consists of a housing part 2 with a plug receptacle 4 for inserting a tubular plug-in part (not shown) for example, a pipe end, made of plastic, such as for example, polyamide, in a fluid-tight manner, a retaining element 6 for locking the inserted plug-in part; and a fluid seal 8 for sealing it, located in the plug receptacle 4. Here the housing part 2 has a two-piece base part 10 consisting of a receiving part 16 for the retaining element 6; and of a connection part 14, which is configured as a screw-in connection piece, for connection of the housing part 2 to a threaded bore of any desired unit (not shown). A support sleeve 12 is preferably arranged within the housing part 2 for supporting engagement with the plug-in part to be inserted.

According to the invention, the fluid seal 8 for sealing the plug-in part, which is inserted into the plug receptacle 4, is arranged radially between the connection part 14 and the tubular plug-in part. This eliminates the need for a pressure seal in the region of the receiving part 16 and also for an additional seal between the connection part 14 and receiving part 16.

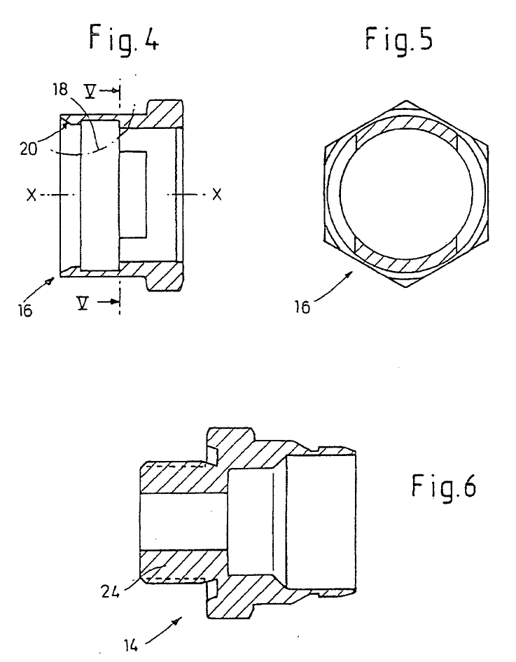

FIGS. 1 to 3 show that the receiving part 16 is configured as a collar part which surrounds the connection part 14 in certain regions in a sleeve-like manner, can preferably be clipped onto the connection part 14 and is made of plastic. The collar part 16 is shown in FIGS. 4 and 5 as an individual part. A catch region, which is denoted by reference numeral 18 and circumscribed in FIG. 4 by an arc of a circle, of the collar part 16 is sufficiently resilient that no damage occurs during clipping-on. In this case, it is also possible to provide the collar part in the catch region with an axial slot (formed parallel to the longitudinal axis X-X).

As mentioned above, when fitted, the fluid seal 8, for example an O-ring, lies in the connection part 14 which can especially be made of metal, for example brass and is shown as an individual part in an embodiment as a screw-in connection piece in FIG. 6.

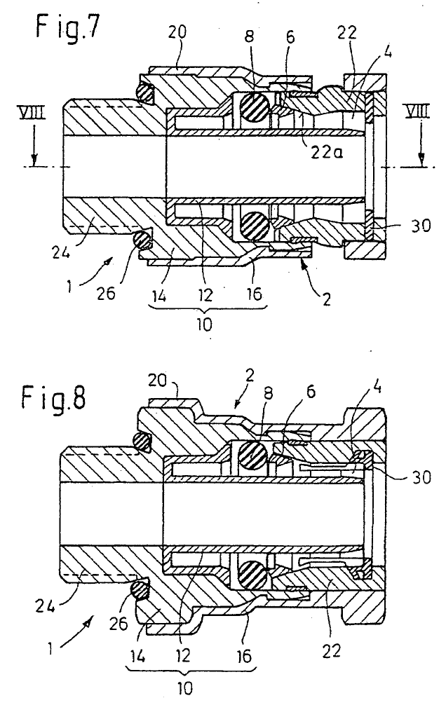

As FIGS. 7 and 8 show, the collar part 16, which is configured as a plastic receiving part, can externally surround a polygonal, especially hexagonal, outer contour of the connection part 14 with a bushing portion 20. To this extent, the collar part 16 may be regarded as a component of the housing part 2. The plastic can in this case advantageously surround in particular just two undersized key surfaces of the connection part 14. Rotation can be prevented also by knurling on one or both or the components 16 or 14 if the region between these parts is designed as a press fit. This can also be achieved by way of a press region without knurling. A frictional moment occurring during rotation for setting the angular positions should advantageously assume preferred values of greater than 10 Nm.

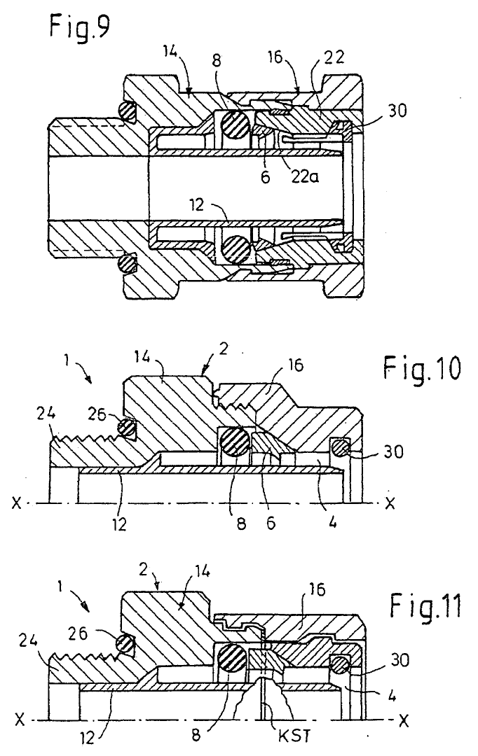

The collar part 16 can also be fastened to the connection part 14 differently, for example by screwing-on. Thus, it is also possible to embody the collar part 16, which surrounds the connection part 14, as a screw-on plastic or brass part, such as is illustrated in FIG. 9, or to catch it on differently, as is shown in FIG. 10. The configuration of the connection part 14 then also differs accordingly from that shown in FIG. 6.

In a further embodiment, the housing part 2 can also be constructed differently. Whereas in the embodiments according to FIG. 1 to 8 it consists of the base part 10 and an additional insert part 22 connected thereto, wherein the mutual fastening can for example take place as a snap-action positive-fit connection, the embodiment according to FIG. 10 has no such insert part 22. At least some of its functions, such as especially the radial supporting of the retaining element 6 via an inner cone 22a, are performed by the collar part 16 which is configured in this case in the manner of a union element.

As is illustrated in FIG. 9, it is possible as a result of two-part nature according to the invention of the base part 10, which consists of the connection part 14 and the receiving part 16, to insert the insert part 22 “from the inside”, positive-fit mounting being achieved. There is therefore also no need for locking, so that the insert part 22 can be configured as a rigid, relatively non-resilient annular element. Therefore, a dirt seal 30 does not have to be molded on in a multicomponent spraying method, but rather can be inserted simply as a ring seal into an inner annular groove of the insert part 22.

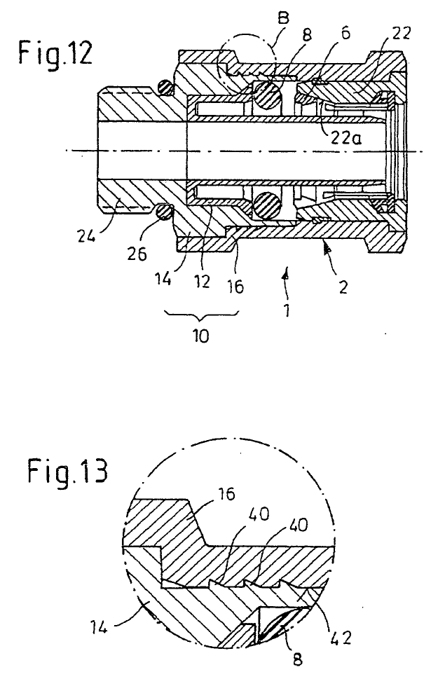

A further embodiment of the invention is illustrated in FIGS. 12 and 13. The characteristic feature of this embodiment consists in the fact—as the enlarged view shown in FIG. 13 shows—that non-positive/positive-fit elements 40 are arranged on the circumference of the connection part 14 to increase the strength of the connection between the connection part 14 of the base part 10 of the housing 2 and the receiving part 16. These elements 40, which are impressed into the inner wall 42 of the receiving part 16, can have a broad range of configurations, but are in the illustrated embodiment advantageously saw tooth-shaped, so that the connection part for pressing to the receiving part 16 is configured in the manner of a drive-in mandrel. The non-positive/positive-fit elements 40 can encircle or be distributed around all or else only part of the circumference.

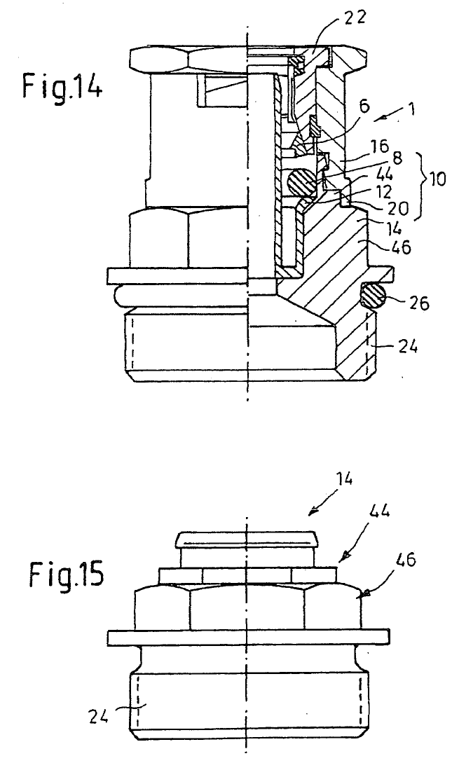

In the embodiment of the invention illustrated in FIGS. 14 and 15, the receiving part 16 externally surrounds—as also shown in FIGS. 7 and 8—a polygonal, especially hexagonal, outer contour of the connection part 14 with a bushing portion 20 with a positive fit, thus preventing the two parts 14, 16 from rotating relative to each other. The surrounded contour of the connection part 14 is denoted by reference numeral 44. In this case, the characteristic feature of this embodiment consists in the fact that the contour 44 surrounded by the receiving part is present in addition to a contour 46 of the connection part 14 that is present as standard and serves to engage a tool key. As a result of this separation of the contours 44, 46, very high tightening moments of the key can advantageously be transmitted to the connection part 14 without damage during assembly or disassembly.

The invention is not limited to the illustrated exemplary embodiments, but rather also encompasses all embodiments which are equivalent in the sense of the convention, as is apparent from the different illustrated designs of the various components.

### LIST OF REFERENCE NUMERALS

1 Plug connector
2 Housing part
4 Plug receptacle of 2
6 Retaining element
8 Fluid seal
10 Base part of 2
12 Support sleeve
14 Connection part of 10
16 Receiving collar part of 10 for 8
18 Catch region of 16
20 Bushing portion of 16
22 Insert part of 2
22a Inner cone
24 Connecting portion of 14
26 Additional threaded seal
30 Dirt seal
40 Non-positive/positive-fit element
42 Inner wall of 16
44 Contour of 14 surrounded by 16
46 Contour of 14 for tool engagement
X-X Longitudinal axis of 1

1. A plug connector for especially inserting a tubular plug-in part in a fluid tight manner, useful for plastic pipe conduits, consisting of a housing part comprising a plug receptacle for inserting the tubular plug-in part; a retaining element for locking the inserted plug-in part; and a fluid seal for sealing the locked plug-in part, the fluid seal being located in the plug receptacle, the housing part having a two-piece base part consisting of a receiving part for the retaining element and a connection part for connecting the housing part to a threaded bore, wherein the fluid seal for sealing the inserted plug-in part is arranged radially between the connection part and the tubular plug-in part.

2. The plug connector of claim 1, wherein the housing part comprises a base part and an insert part connected thereto by a snap-action positive-fit connection.

3. The plug connector of claim 2, wherein the connection part is made of metal, and the receiving part is made of plastic.

4. The plug connector of claim 3, wherein the receiving part is screwed onto the connection part.

5. The plug connector of claim 3, wherein the receiving part is connected in a rotationally fixed manner to the connection part, the receiving part surrounding an outer contour of the connection part whole and being adapted to the shape thereof.

6. The plug connector of claim 1, wherein the outer contour of the connection part (14) is polygonal or knurled in its configuration or comprises two undersized key surfaces.

7. The plug connector of claim 1, having a circumference comprising one or more non-positive/positive-fit elements, impressed into an inner wall of the receiving part, and arranged on the circumference of the connection part to increase the strength of the connection between the connection part of the base part of the housing part and the receiving part.
